(19) United States
(12) Patent Application Publication
(10) Pub. No.: US 2022/0292255 A1
(43) Pub. Date: Sep. 15, 2022

(54) Method and System For Processing Electronic Documents

(71) Applicant: AI DOCK LTD, Rehovot (IL)

(72) Inventors: Sean GALANTZAN, Rehovot (IL); Eddie GALANTZAN, Rehovot (IL); Tomer Shamir, Rehovot (IL)

(21) Appl. No.: 17/597,552

(22) PCT Filed: Jul. 12, 2020
(86) PCT No.: PCT/IL2020/050781

§ 371 Date: Jan. 11, 2022

Related U.S. Application Data
(60) Provisional application No. 62/873,913, filed on Jul. 14, 2019.

(51) Int. Cl. G06F 40/174; G06F 40/131; H04N 1/327

(52) U.S. Cl. CPC G06F 40/174; G06F 40/131; H04N 1/32776

(57) ABSTRACT

Methods and systems provide a rapid data transfer process, as data from a shipping document, which is rendered as a copyable electronic document, is easily transferred to a receiving electronic document, such as an Enterprise Resource Planning (ERP) form. The data is transferred, for example, as text, e.g., a complete line item of text, photograph or other graphic, or combinations thereof.

### CROSS REFERENCES TO RELATED APPLICATIONS

This application is related to and claims priority from commonly owned U.S. Provisional Patent Application Ser. No. 62/873,913, entitled: METHOD AND SYSTEM FOR PROCESSING ELECTRONIC DOCUMENTS, filed on Jul. 14, 2019, the disclosure of which is incorporated by reference in its entirety herein.

### TECHNICAL FIELD

The present disclosure is directed to text and graphics transfer between electronic documents.

### BACKGROUND

Presently, the transfer of data between shipping documents and an Enterprise Resource Planning (ERP) form is performed manually by data entry clerks manually entering data from the shipping document to the ERP form. This process is manual, and thus, time consuming and expensive, and also subject to human error.

### SUMMARY OF THE DISCLOSED SUBJECT MATTER

The present disclosure (disclosed subject matter) provides for a rapid data transfer process, while lessening the chances for human error involved with data transfer, as data from a shipping document, which is rendered as a copyable electronic document, is easily transferred to a receiving electronic document, such as an Enterprise Resource Planning (ERP) form. The data is transferred, for example, as text, e.g., a complete line item of text, photograph or other graphic, or combinations thereof.

The present disclosed subject matter renders documents in various formats, to an ERP system, where the data from the rendered document is transferrable from the rendered electronic document to an ERP form.

Embodiments of the disclosed subject matter are directed to a computer-implemented method for transferring at least one of text and/or graphics between at least two documents, typically electronic documents. The method comprises: obtaining a first electronic document associated with a request to print the first electronic document; creating a modified first electronic document including parsing the data from the first electronic document, such that the data is removable from the first electronic document; and, transmitting the modified first electronic document to an intended destination, the modified first electronic document such that data can be transferred from the modified first electronic document to a second electronic document of the computer system of the intended recipient.

Optionally, the computer-implemented method is such that the request to print the first electronic document is received by a resource which mimics a printer.

Optionally, the computer-implemented method is such that the request to print the first electronic document is received by a printer.

Optionally, the computer-implemented method is such that the resource which mimics a printer is configured for protocols including Internet Printing Protocol (IPP), and is based on the receiving of the first electronic document in the Internet Printing Protocol (IPP).

Optionally, the computer-implemented method is such that the printer is configured for protocols including Internet Printing Protocol (IPP), based on the receiving of the first electronic document in the Internet Printing Protocol (IPP).

Optionally, the computer-implemented method is such that the obtaining the first electronic document includes receiving the first electronic document from the intended recipient.

Optionally, the computer-implemented method is such that the obtaining the first electronic document additionally includes receiving the first electronic document by a resource which mimics a printer, and, transmitting the first electronic document to a computer to create the modified first electronic document.

Optionally, the computer-implemented method is such that the second electronic document includes an Enterprise Resource Planning (ERP) electronic document.

Optionally, the computer-implemented method is such that the parsing the data from the first electronic document includes parsing one or more of text and/or graphics from the first electronic document such that the parsed text and/or graphics can be transferred from the modified first electronic document to a second electronic document.

Optionally, the computer-implemented method is such that the transmitting the modified first electronic document to the intended destination includes at least one of: 1) transmitting the modified first electronic document to the intended destination via the resource which mimics a printer, 2) transmitting the modified first electronic document to the intended destination via the printer, or 3) transmitting the modified first electronic document directly to the intended destination.

Optionally, the computer-implemented method is such that the intended destination includes a computer along a communications network.

Optionally, the computer-implemented method is such that the communications network includes a wide area network (WAN).

Optionally, the computer-implemented method is such that the communications network includes the Internet.

Embodiments of the disclosed subject matter are directed to a computer system for transferring at least one of text, photographs, and/or graphics between at least two documents. The system comprises: a first computer for obtaining a first electronic document associated with a request to print the first electronic document; and, a second computer for creating a modified first electronic document including parsing the data from the first electronic document, such that the data is removable from the first electronic document, and, transmitting the modified first electronic document to an intended destination, the modified first electronic document such that data can be transferred from the modified first electronic document to a second electronic document of the computer system of the intended recipient.

Optionally, the computer system is such that the first computer includes a computerized component which mimics a printer.

Optionally, the computer system is such that the resource which mimics a printer is configured for protocols including Internet Printing Protocol (IPP), based on the receiving of the first electronic document in the Internet Printing Protocol (IPP).

Optionally, the computer system is such that the first computer for obtaining the first electronic document receives the first electronic document from the intended recipient.

Optionally, the computer system is such that the first computer transmits the first electronic document to the second computer to create the modified first electronic document.

This document references terms that are used consistently or interchangeably herein. These terms, including variations thereof, are as follows.

A “computer” includes machines, computers and computing or computer systems (for example, physically separate locations or devices), servers, computer and computerized devices, processors, processing systems, computing cores (for example, shared devices), and similar systems, workstations, modules and combinations of the aforementioned. The aforementioned “computer” may be in various types, such as a personal computer (e.g., laptop, desktop, tablet computer), or any type of computing device, including mobile devices that can be readily transported from one location to another location (e.g., smartphone, personal digital assistant (PDA), mobile telephone or cellular telephone).

A “server” is typically a remote computer or remote computer system, or computer program therein, in accordance with the “computer” defined above, that is accessible over a communications medium, such as a communications network or other computer network, including the Internet. A “server” provides services to, or performs functions for, other computer programs (and their users), in the same or other computers. A server may also include a virtual machine, a software based emulation of a computer.

An “application” or “software application”, includes executable software, and optionally, any graphical user interfaces (GUI), through which certain functionalities can be implemented.

Unless otherwise defined herein, all technical and/or scientific terms used herein have the same meaning as commonly understood by one of ordinary skill in the art to which the disclosed subject matter pertains. Although methods and materials similar or equivalent to those described herein may be used in the practice or testing of embodiments of the disclosed subject matter, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present disclosed subject matter are herein described, by way of example only, with reference to the accompanying drawings. With specific reference to the drawings in detail, it is stressed that the particulars shown are by way of example and for purposes of illustrative discussion of embodiments of the disclosed subject matter. In this regard, the description taken with the drawings makes apparent to those skilled in the art how embodiments of the disclosed subject matter may be practiced.

Attention is now directed to the drawings, where like reference numerals or characters indicate corresponding or like components. In the drawings:

FIG. 1 is a diagram of an exemplary environment in which embodiments of the disclosed subject matter are performed;

FIG. 2 is a flow diagram of an example process in accordance with embodiments of the disclosed subject matter; and,

FIG. 3A-1 is a diagram of an invoice as an electronic document;

FIG. 3A-2 is a diagram of an Enterprise Resource Planning (ERP) form as an electronic document;

FIG. 3B-1 is a screen diagram of an invoice ad ERP form displayed side-by side;

FIG. 3B-2 is a screen diagram of an invoice and ERP form displayed side-by side, showing the ERP form being populated with text from the invoice; and,

FIG. 3B-3 is a screen diagram of an invoice ad ERP form displayed side-by side, showing the ERP form being populated with text from the invoice having been completed.

### DETAILED DESCRIPTION OF THE DRAWINGS

Before explaining at least one embodiment of the disclosed subject matter in detail, it is to be understood that the disclosed subject matter is not necessarily limited in its application to the details of construction and the arrangement of the components and/or methods set forth in the following description and/or illustrated in the drawings. The disclosed subject matter is capable of other embodiments or of being practiced or carried out in various ways.

As will be appreciated by one skilled in the art, aspects of the present disclosed subject matter may be embodied as a system, method or computer program product. Accordingly, aspects of the present disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosed subject matter may take the form of a computer program product embodied in one or more non-transitory computer readable (storage) medium(s) having computer readable program code embodied thereon.

Throughout this document, numerous textual and graphical references are made to trademarks, and domain names. These trademarks and domain names are the property of their respective owners, and are referenced only for explanation purposes herein.

Embodiments of the disclosed subject matter are directed to a computer-implemented method for transferring at least one of text and/or graphics between at least two documents, for example, electronic documents in conventional document formats, such as portable document format (PDF) and the like. The method comprises: obtaining a first electronic document associated with a request to print the first electronic document; creating a modified first electronic document including parsing the data from the first electronic document, such that the data is removable from the first electronic document; and, transmitting the modified first electronic document to an intended destination, the modified first electronic document such that data can be transferred from the modified first electronic document to a second electronic document of the computer system of the intended recipient. The computer-implemented method is such that the request to print the first electronic document is received, for example, by either a virtual printer, for example, a resource which mimics a printer, or a real printer.

Embodiments of the disclosed subject matter are directed to a computer system for transferring at least one of text, photographs, and/or graphics between at least two documents, for example, electronic documents in conventional document formats, such as portable document format (PDF) and the like. The system comprises: a first computer for obtaining a first electronic document associated with a request to print the first electronic document; and, a second computer for creating a modified first electronic document including parsing the data from the first electronic document, such that the data is removable from the first electronic document, and, transmitting the modified first electronic document to an intended destination, the modified first electronic document such that data can be transferred from the modified first electronic document to a second electronic document of the computer system of the intended recipient.

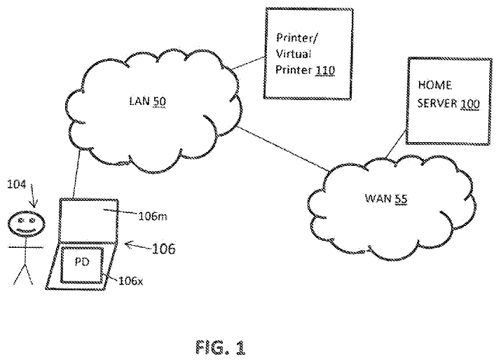

FIG. 1 shows an example environment in which the disclosed subject matter operates. The environment includes a Local Area Network (LAN) 50, such as an Enterprise Network, linked to a Wide Area Network (WAN) 55, which is, for example, a public network, such as the Internet. The networks LAN 50 and WAN 55, although shown as single networks, may be a combination of networks and/or multiple networks including, for example, data networks, cellular networks, communications networks, and the like. “Linked” as used herein, includes both wired and/or wireless links, either direct or indirect, such that the networks, computers, including, servers, components and the like, are in electronic and/or data communications with each other.

A home server 100, which includes a system for performing the disclosed subject matter, links to the WAN 55 and is in electronic and/or data communication with the LAN 50 and components linked thereto. The Home Server 100 functions to receive electronic documents from the virtual printer 110 of the LAN 50, and parse the electronic documents into “broken” documents, also known as “modified” documents, such that the portions of text, photos and the like, from the documents can be copied or transferred from the “broken” document into other electronic documents, for example, Enterprise Resource Planning (ERP) documents held by users (intended recipients). The home server 100 uses programs such as Google® OCR or Google Vision AI (https://cloud.google.com/vision) to render electronic documents suitable for having the text, graphics, and the like, thereon copied or transferred into other electronic documents, or systems, such as an Enterprise Resource Planning (ERP) system (intended recipient).

The home server 100 may output the “broken” document as a JSON (JavaScript Object Notation) file. JSON is a lightweight data-interchange format, which is easy for machines to parse and generate, and is based on a subset of the JavaScript Programming Language, Standard ECMA-262 3rd Edition-December 1999. The home server 100 then transmits (sends) the “broken” electronic document to the user computer 106, for example, via the printer/virtual printer 110.

A user 104, represented by his computer 106 (including a monitor 106m for display, and a printer driver (PD) 106x, loaded onto the computer 106), is linked to the LAN 50. This user 104 and computer is representative of multiple similar users (and computers) linked to the LAN 50. For example, the user 104 is a data entry person working with electronic shipping and other customs documents. The printer driver (PD) 106x includes software that converts the data to be printed to a format that a printer, such as the printer/virtual printer 110 can understand, and to allow applications to do printing without being aware of the technical details of each printer model. For example, the PD 106x works with any file format that supports printing using the Internet Printing Protocol (IPP) is

A printer/virtual printer 110 is also linked to the LAN 50, and received electronic documents from the user computer 106, for actual printing, as well as virtual printing. This virtual printer 110 mimics an actual printer, and recreates digital documents that it receives from the user computers 106. Such virtual printing shows the electronic form as it will be printed, such as a “Print Preview” function on MSWORD®. The printer/virtual printer 110 maps to the home server 100, such that when a document arrives at the printer/virtual printer 110, it is automatically transmitted (sent) to the home server 100, and typically vice versa (once the electronic document is passed and rendered as copyable). The printer/virtual printer 110, for example, may be a resource (e.g., computer or computer component in hardware, software, or combinations thereof) which may, for example, reside in the cloud.

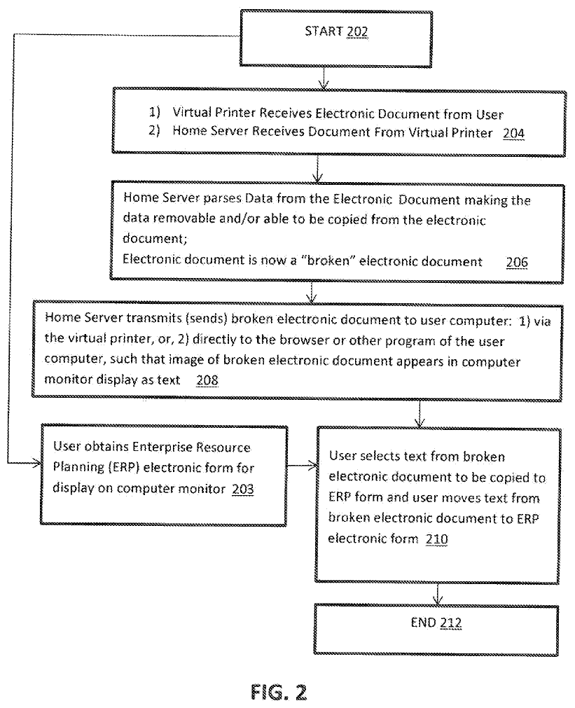

Attention is now directed to FIG. 2, which show a flow diagram detailing computer-implemented processes in accordance with embodiments of the disclosed subject matter. Reference is also made to elements shown in FIGS. 1 and 3A-1, 3A-2, 3B-1, 3B-2 and 3B-3. The process and sub-processes of FIG. 2 are computerized processes performed by the system, as embodied, for example, in the home server 100. The aforementioned processes and sub-processes can be, for example, performed manually, automatically, or a combination thereof, and, for example, in real time.

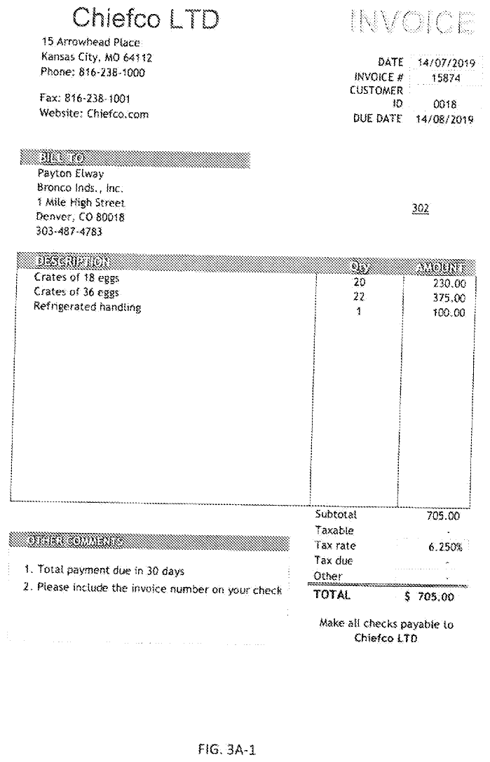

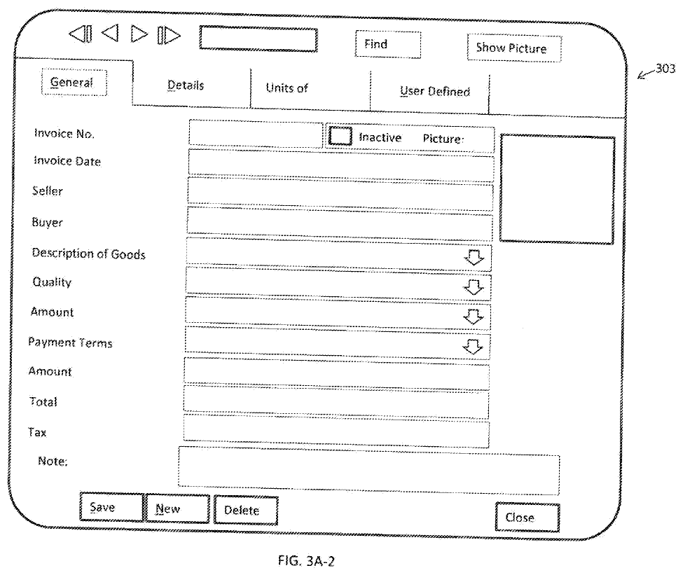

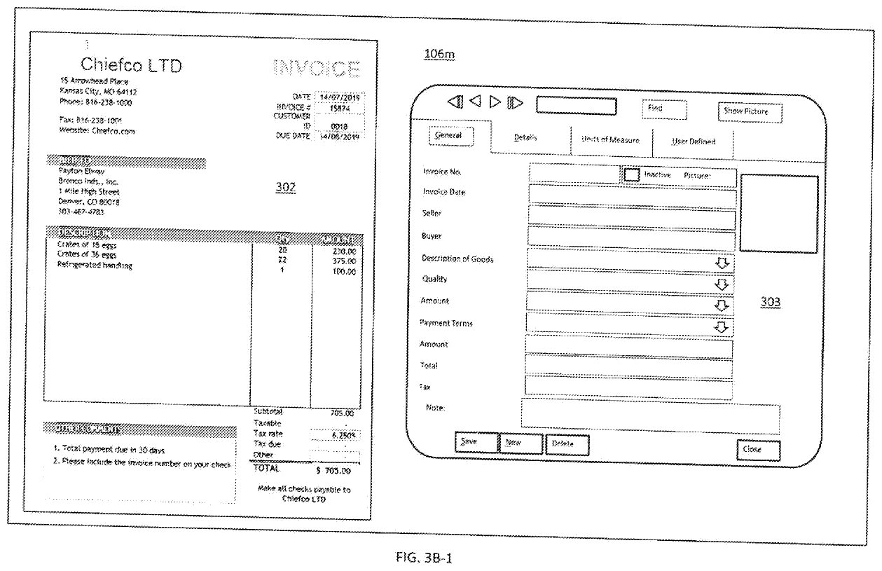

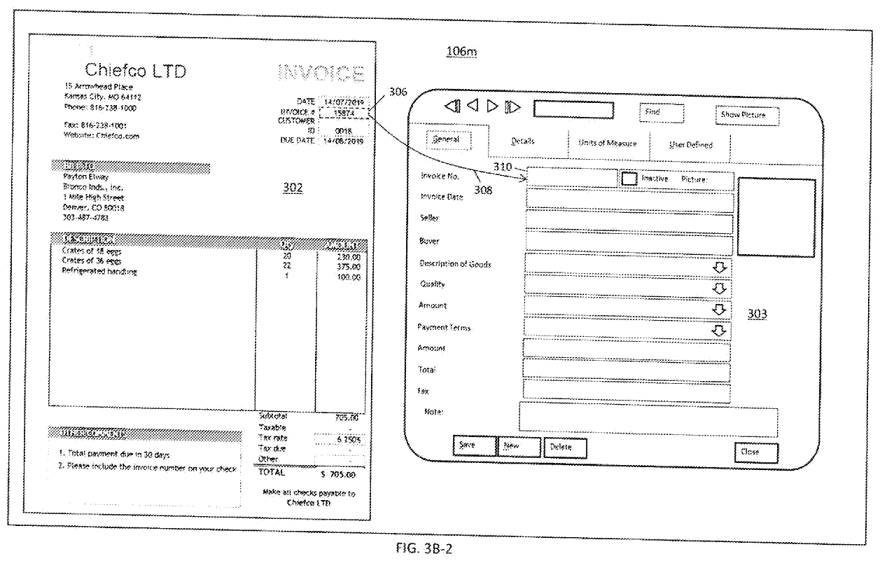

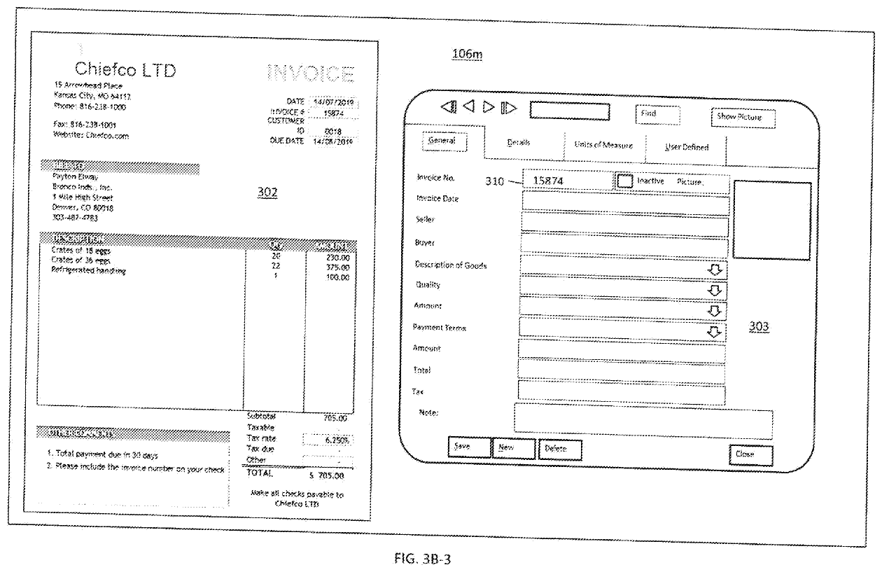

The process begins at a START block 202, where the user 104 has, for example, on the user computer, has a standard invoice 302 in an electronic format, as shown in FIG. 3A-1, and has obtained an enterprise Resource Planning (ERP) electronic document (form) 303, as shown for example, in FIG. 3A-2, to which text, graphs, and the like therefor, is to be acquired and/or manually entered, at block 203.

Also, from block 202, the process moves to block 204, where the virtual printer 110 receives the electronic document 302 from the user 104 (user computer 106). The electronic document 302, for example, is transmitted using the Internet Printing Protocol (IPP). The electronic document may be an invoice in electronic format, or as converted into electronic format, so as to be an electronic document 302, as shown in FIG. 3A-1. The electronic document 302 is received by the virtual printer 110, for example, with a request to print the first electronic document.

The virtual printer 110 subsequently transmits the electronic document 302 to the home server 100, where the electronic document 302 (or a recreated version or form thereof, created by the virtual printer 110) is received.

For example, at block 202, when the virtual printer receives the transmission of the electronic document 302, for example as a request to print the electronic document 302, the virtual printer 110 saves the Internet Protocol (IP) address of the user computer 106, from where the request was sent. After the request is completed, the virtual printer 110 and/or the home server 100 correlate between the client, e.g., the user computer 106, IP, and the print document request IP.

At block 206, the home server 100 parses data from the electronic document 302 making the data removable as text, photographs, graphics and the like, and/or able to be copied from the electronic document 302. The electronic document 302 with copyable or transferrable text, photographs, graphics and the like, is now a “broken” electronic document. These “broken” documents are such that the portions of text, photos and the like, from the documents can be copied or transferred into other electronic documents, or systems, such as an Enterprise Resource Planning (ERP) system. The home server 100 uses programs such as Google® OCR or Google Vision AI (https://cloud.google.com/vision) to render electronic documents suitable for having the text, graphics, and the like, thereon copied.

The home server 100 may output the “broken” document as a JSON (JavaScript. Object Notation) file. JSON is a lightweight data-interchange format, which is easy for machines to parse and generate, and is based on a subset of the JavaScript Programming Language, Standard ECMA-262 3rd Edition-December 1999.

At block 208, the home server 100 transmits (sends) the “broken” electronic document to the user computer 106, via the virtual printer 110 (detailed above). Alternately, the home server 100 transmits (sends) the “broken” electronic document directly to the user computer 106, to its browser or other program of the user computer 106. The process by which the broken electronic is transmitted to the user computer 206 depends, for example, on the security policy associated with the LAN. For example, if the LAN is protected by a firewall, the broken electronic document is typically transmitted to the user computer 106, via the virtual printer 110. The image of the broken electronic document 302, displays on the computer monitor 106m as text, graphics and/or the like, in a manner identical or similar to the original electronic document 302, in FIG. 3A-1.

Also at block 208, when the processing of the print request is complete, the home server 100 finds the client, e.g., user computer, with the same IP as the print document request (e.g., the client which requested the electronic document 302 for processing), and sends the processed or “broken” document to that client, who is, for example, the intended recipient.

From block 203 and block 208, the process moves to block 210. At block 210, a user 104 (e.g., the intended recipient) selects text, graphics, or the like from the now-displayed (on the computer monitor 106m) broken electronic document (which displays like the original document 302 of FIG. 3A-1). This selected text, graphics, or the like, is that which is to be copied to a second electronic document (form), for example, an electronic Enterprise Resource Planning (ERP) form 303 (also known as an ERP electronic document or document), by the user 104 moving text, graphics, and the like, from the broken electronic document, for example, the invoice 302, to the ERP electronic document 303, as shown in FIG. 3B-1 (a screen diagram where the invoice 302 (now the broken electronic document) and ERP form 303 are displayed side by side on the computer monitor 106m of the user computer 106). This side by side arrangement of the electronic documents 302, 303 allows for the on-screen transfer of text, graphics, and the like from the invoice 302 to the ERP form 303.

In order to receive the broken electronic document 302, at the user computer 106, the user 104, for example installs software specifically for receiving broken documents and other data, including documents, from the home server 100 or connects to a web service, associated with the home server 100 and/or the virtual printer. For example, in the case of the connection to the web service, the IP of the web service detects the IP of user computer, or client, to allow for the transmission of the broken document.

FIG. 3B-2 (a screen diagram of the computer monitor 106m) shows the broken text, for example the Invoice Number (shown by the broken line box 306) of the Invoice 302, the broken line box 306 representative of a covering of the text “15874”, so that it can be moved, by dragging/dropping, copy/paste, represented by the arrow 308, to the corresponding “Invoice Number” box 310 on the ERP form 303. FIG. 3B-3 (a screen diagram of the computer monitor 106m) shows box 310 on the ERP form 303 having been populated with the moved text, i.e., the Invoice Number “15874”.

The process moves to block 212, where it ends. The process may be repeated for as many iterations as necessary and/or desired.

Implementation of the method and/or system of embodiments of the disclosed subject matter can involve performing or completing selected tasks manually, automatically, or a combination thereof. Moreover, according to actual instrumentation and equipment of embodiments of the method and/or system of the disclosed subject matter, several selected tasks could be implemented by hardware, by software or by firmware or by a combination thereof using an operating system.

For example, hardware for performing selected tasks according to embodiments of the disclosed subject matter could be implemented as a chip or a circuit. As software, selected tasks according to embodiments of the disclosed subject matter could be implemented as a plurality of software instructions being executed by a computer using any suitable operating system. In an exemplary embodiment of the disclosed subject matter, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, non-transitory storage media such as a magnetic hard-disk and/or removable media, for storing instructions and/or data. Optionally, a network connection is provided as well. A display and/or a user input device such as a keyboard or mouse are optionally provided as well.

For example, any combination of one or more non-transitory computer readable (storage) medium(s) may be utilized in accordance with the above-listed embodiments of the present disclosed subject matter. A non-transitory computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable non-transitory storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

As will be understood with reference to the paragraphs and the referenced drawings, provided above, various embodiments of computer-implemented methods are provided herein, some of which can be performed by various embodiments of apparatuses and systems described herein and some of which can be performed according to instructions stored in non-transitory computer-readable storage media described herein. Still, some embodiments of computer-implemented methods provided herein can be performed by other apparatuses or systems and can be performed according to instructions stored in computer-readable storage media other than that described herein, as will become apparent to those having skill in the art with reference to the embodiments described herein. Any reference to systems and computer-readable storage media with respect to the following computer-implemented methods is provided for explanatory purposes, and is not intended to limit any of such systems and any of such non-transitory computer-readable storage media with regard to embodiments of computer-implemented methods described above. Likewise, any reference to the following computer-implemented methods with respect to systems and computer-readable storage media is provided for explanatory purposes, and is not intended to limit any of such computer-implemented methods disclosed herein.

The flowcharts and block diagrams in the Figures illustrate the architecture, functionality, and operation of possible implementations of systems, methods and computer program products according to various embodiments of the present disclosed subject matter. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present disclosed subject matter have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the disclosed subject matter, which are, for clarity, described in the context of separate embodiments, may also be provided in combination in a single embodiment. Conversely, various features of the disclosed subject matter, which are, for brevity, described in the context of a single embodiment, may also be provided separately or in any suitable subcombination or as suitable in any other described embodiment of the disclosed subject matter. Certain features described in the context of various embodiments are not to be considered essential features of those embodiments, unless the embodiment is inoperative without those elements.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

Although the disclosed subject matter has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A computer-implemented method for transferring at least one of text and/or graphics between at least two documents comprising:
obtaining a first electronic document associated with a request to print the first electronic document;
creating a modified first electronic document including parsing the data from the first electronic document, such that the data is removable from the first electronic document; and, transmitting the modified first electronic document to an intended destination, the modified first electronic document such that data can be transferred from the modified first electronic document to a second electronic document of the computer system of the intended recipient.

2. The computer-implemented method of claim 1, wherein the request to print the first electronic document is received by a resource which mimics a printer.

3. The computer-implemented method of claim 1, wherein the request to print the first electronic document is received by a printer.

4. The computer-implemented method of claim 2, wherein the resource which mimics a printer is configured for protocols including Internet Printing Protocol (IPP), based on the receiving of the first electronic document in the Internet Printing Protocol (IPP).

5. The computer-implemented method of claim 3, wherein the printer is configured for protocols including Internet Printing Protocol (IPP), based on the receiving of the first electronic document in the Internet Printing Protocol (IPP).

6. The computer-implemented method of claim 1, wherein the obtaining the first electronic document includes receiving the first electronic document from the intended recipient.

7. The computer-implemented method of claim 6, wherein the obtaining the first electronic document additionally includes receiving the first electronic document by a resource which mimics a printer, and, transmitting the first electronic document to a computer to create the modified first electronic document.

8. The computer-implemented method of claim 1, wherein the second electronic document includes an Enterprise Resource Planning (ERP) electronic document.

9. The computer-implemented method of claim 1, wherein the parsing the data from the first electronic document includes parsing one or more of text and/or graphics from the first electronic document such that the parsed text and/or graphics can be transferred from the modified first electronic document to a second electronic document.

10. The computer-implemented method of claim 1, wherein the transmitting the modified first electronic document to the intended destination includes at least one of: 1) transmitting the modified first electronic document to the intended destination via the resource which mimics a printer, 2) transmitting the modified first electronic document to the intended destination via the printer, or 3) transmitting the modified first electronic document directly to the intended destination.

11. The computer-implemented method of claim 1, wherein the intended destination includes a computer along a communications network.

12. The computer-implemented method of claim 1, wherein the communications network includes a wide area network (WAN).

13. The computer-implemented method of claim 1, wherein the communications network includes the Internet.

14. A computer system for transferring at least one of text, photographs, and/or graphics between at least two documents comprising:
a first computer for obtaining a first electronic document associated with a request to print the first electronic document; and,
a second computer for creating a modified first electronic document including parsing the data from the first electronic document, such that the data is removable from the first electronic document, and, transmitting the modified first electronic document to an intended destination, the modified first electronic document such that data can be transferred from the modified first electronic document to a second electronic document of the computer system of the intended recipient.

15. The computer system of claim 14, wherein the first computer includes a computerized component which mimics a printer.

16. The computer system of claim 15, wherein the resource which mimics a printer is configured for protocols including Internet Printing Protocol (IPP), based on the receiving of the first electronic document in the Internet Printing Protocol (IPP).

17. The computer system of claim 14, wherein the first computer for obtaining the first electronic document receives the first electronic document from the intended recipient.

18. The computer system of claim 15, wherein the first computer transmits the first electronic document to the second computer to create the modified first electronic document.
